(19) United States
(12) Patent Application Publication
(10) Pub. No.: US 2025/0244726 A1
(43) Pub. Date: Jul. 31, 2025

(54) FUZZY-NEURAL INTEGRATION FOR PRODUCTION INDEX PREDICTION

(71) Applicant: Saudi Arabian Oil Company, Dhahran (SA)

(72) Inventors: James Ohioma Arukhe, Dhahran (SA); Suhail Samman, Riyadh (SA); Torty Kalu-Ulu, Ras Tanura (SA)

(21) Appl. No.: 18/422,207

(22) Filed: Jan. 25, 2024

(51) Int. Cl. G05B 13/02

(52) U.S. Cl. CPC G05B 13/0285

(57) ABSTRACT

The determination of a production index for a selected well using a fuzzy logic and neural network model (a “fuzzy-neural model”). Input data may be obtained from one or more producing wells and preprocessed for use in training and testing. The preprocessed data may be fuzzified into fuzzy values using fuzzy sets, membership functions, and a rule base. The neural network may be trained using the fuzzy values from the fuzzification to output the production index. The trained fuzzy-neural model may then be used to determine a production index for new data from the selected well.

### BACKGROUND

### Field of the Disclosure

The present disclosure generally relates to the production of hydrocarbons such as oil and gas from wells accessing a reservoir. More specifically, embodiments of the disclosure relate to determining the production capabilities of such wells.

### Description of the Related Art

A hydrocarbon reservoir is a pool of hydrocarbons (for example, oil or gas) trapped in a subsurface rock formation. Hydrocarbon wells are often drilled into hydrocarbon reservoirs to extract (or “produce”) the trapped hydrocarbons. In many instances, hydrocarbon wells are drilled and operated in a manner to optimize production of hydrocarbons. For example, a reservoir is typically assessed to identify characteristics of the reservoir (for example, locations and amount of hydrocarbons and other substances trapped in the reservoir and properties of the rock forming the reservoir), the locations and trajectories (or “paths”) of wells to be drilled into the reservoir are determined based on the characteristics, the wells are drilled into the reservoir in accordance with the locations and trajectories, and the wells are operated to facilitate efficient extraction of the hydrocarbons from the reservoir.

During the production stage of a well, a well operator typically engages in operations to optimize the overall production of hydrocarbons from the reservoir. This optimization can include regulating well operating flow rates and pressures based on characteristics of the wellbore, the formation, the production, and operations of nearby wells. Accurately determining the production from each well accessing a reservoir and how to optimize the production may present numerous challenges.

### SUMMARY

The performance (that is, productivity) of a producing well accessing a hydrocarbon reservoir may be quantified by a “production index” (PI), also known as a “productivity index.” The accurate prediction of this index may be difficult due to the complex factors affecting the dynamic behavior of a reservoir, such as the properties of the reservoir rock and fluids, well characteristics, and production history.

Traditional prediction techniques for a production index are often based on simplified mathematical models or statistical analysis and may not effectively account for all the factors affecting the dynamic behavior of a reservoir or may oversimplify their interactions. This may result in inaccurate predictions and produce sub-optimal decision-making in reservoir management, resulting in inefficient recovery strategies, higher production costs, or damage to the reservoir.

Production dynamic analysis techniques such as oilfield numerical simulation, characteristic curve analysis, production decline analysis, material balance analysis, analogy methods, empirical formula approaches, chart-based methods, and others have also been used in oilfield production. These techniques have significant limitations due to the complex factors that influence the dynamic prediction of production indices.

In one embodiment, a method for determining the production index of a selected well is provided. The method includes obtaining a first plurality of parameters and respective values associated with one or more producing wells, processing the plurality of parameters and respective values to obtain a training dataset and testing dataset, and fuzzifying the training dataset. The fuzzifying includes creating a plurality of fuzzy sets, each fuzzy set including a plurality of fuzzy inputs and creating a plurality of rules that produce a plurality of fuzzy values for a production index from the plurality of fuzzy inputs. The method further includes training a neural network using the plurality of a fuzzy values for the production index to create a fuzzy-neural model and using the trained fuzzy-neural model to determine a production index for the selected well from a second plurality of parameters and respective values associated with the selected well.

In some embodiments, processing the plurality of parameters and respective values including normalizing the plurality of respective values to a range. In some embodiments, the first plurality of parameters includes a plurality of reservoir properties. In some embodiments, the first plurality of parameters includes a plurality of well characteristics. In some embodiments, the first plurality of parameters includes a production rate. In some embodiments, the neural network is a feed-forward neural network. In some embodiments, the method includes evaluating the fuzzy-neural model before using the trained fuzzy-neural model to determine a production index for the selected well, such that evaluating the fuzzy-neural model includes calculating a metric between a production index produced by the fuzzy-neural model and a production index in the training data, such that the metric includes a mean absolute error, a mean squared error, or a root mean squared error. In some embodiments, the method includes adjusting the fuzzy-neural model based on the evaluation of the fuzzy-neural model, such that adjusting the fuzzy-neural model includes modifying the neural network, tuning a hyperparameter of the neural network, or modifying the plurality of rules. In some embodiments, the method includes determining, based on production index, an operating parameter for the producing well and operating the hydrocarbon well in accordance with the operating parameter.

In another embodiment, a non-transitory computer readable storage medium having program instructions stored thereon for determining the production index of a selected well. The program instructions are executable by a processor to perform operations that include obtaining a first plurality of parameters and respective values associated with one or more producing wells, processing the plurality of parameters and respective values to obtain a training dataset and testing dataset, and fuzzifying the training dataset. The fuzzifying includes creating a plurality of fuzzy sets, each fuzzy set including a plurality of fuzzy inputs and creating a plurality of rules that produce a plurality of fuzzy values for a production index from the plurality of fuzzy inputs. The operations further include training a neural network using the plurality of a fuzzy values for the production index to create a fuzzy-neural model and using the trained fuzzy-neural model to determine a production index for the selected well from a second plurality of parameters and respective values associated with the selected well.

In some embodiments, processing the plurality of parameters and respective values including normalizing the plurality of respective values to a range. In some embodiments, the first plurality of parameters includes a plurality of reservoir properties. In some embodiments, the first plurality of parameters includes a plurality of well characteristics. In some embodiments, the first plurality of parameters includes a production rate. In some embodiments, the neural network is a feed-forward neural network. In some embodiments, the operations include evaluating the fuzzy-neural model before using the trained fuzzy-neural model to determine a production index for the selected well, such that evaluating the fuzzy-neural model includes calculating a metric between a production index produced by the fuzzy-neural model and a production index in the training data, such that the metric includes a mean absolute error, a mean squared error, or a root mean squared error. In some embodiments, the operations include adjusting the fuzzy-neural model based on the evaluation of the fuzzy-neural model, such that adjusting the fuzzy-neural model includes modifying the neural network, tuning a hyperparameter of the neural network, or modifying the plurality of rules. In some embodiments, the operations include determining, based on production index, an operating parameter for the producing well and operating the hydrocarbon well in accordance with the operating parameter.

In another embodiment, a system for determining the production index of a selected well is provided. The system includes a processor and a non-transitory computer-readable memory accessible by the processor and having executable code stored thereon. The executable code includes a set of instructions that causes a processor to perform operations that include obtaining a first plurality of parameters and respective values associated with one or more producing wells, processing the plurality of parameters and respective values to obtain a training dataset and testing dataset, and fuzzifying the training dataset. The fuzzifying includes creating a plurality of fuzzy sets, each fuzzy set including a plurality of fuzzy inputs and creating a plurality of rules that produce a plurality of fuzzy values for a production index from the plurality of fuzzy inputs. The operations further include training a neural network using the plurality of a fuzzy values for the production index to create a fuzzy-neural model and using the trained fuzzy-neural model to determine a production index for the selected well from a second plurality of parameters and respective values associated with the selected well.

In some embodiments, processing the plurality of parameters and respective values including normalizing the plurality of respective values to a range. In some embodiments, the first plurality of parameters includes a plurality of reservoir properties. In some embodiments, the first plurality of parameters includes a plurality of well characteristics. In some embodiments, the first plurality of parameters includes a production rate. In some embodiments, the operations include determining, based on production index, an operating parameter for the producing well and operating the hydrocarbon well in accordance with the operating parameter.

### BRIEF DESCRIPTION OF THE DRAWINGS

FIG. 1 is a schematic diagram that illustrates a well environment in accordance with an embodiment of the disclosure;

FIG. 2 is a flowchart that illustrates a process for determining a production index of a hydrocarbon well in accordance with an embodiment of the disclosure;

FIG. 3 is a block diagram illustrating certain aspects of a process for determining a production index using a fuzzy-neural model in accordance with embodiment of the disclosure;

FIG. 4 is a flowchart of a process for the fuzzy-neural model for predicting prediction index in accordance with an embodiment of the disclosure;

FIG. 5 is a block diagram of a data processing system in accordance with an embodiment of the disclosure;

FIG. 6 is a graph of example fuzzy sets for production rate in accordance with an embodiment of the disclosure;

FIG. 7 is a flowchart summarizing an example rule base in accordance with an embodiment of the disclosure;

FIG. 8 is a block diagram of a neural network structure in accordance with an embodiment of the disclosure;

FIG. 9 is a flowchart depicting an example of fuzzy-neural model refinement with feedback loops in accordance with an embodiment of the disclosure;

FIG. 10 is a flowchart depicting the iterative improvement of a fuzzy-neural model in accordance with an embodiment of the disclosure; and

FIG. 11 is a graph of Actual Production Index and the Predicted Production Index 1104 in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to the prediction (that is, determination) of a production index for a producing well using a fuzzy logic and neural network model (referred to herein as a “fuzzy-neural”) model. As known in the art, a production index is typically expressed in units of volume per unit pressure drop. For oil reservoirs, production index may be expressed in barrels per day per pounds per square inch (bbl/day/psi). For gas reservoirs, production index may be expressed in standard cubic feet per day per psi (scf/day/psi). Embodiments of the disclosure may use either unit depending on the type of reservoir.

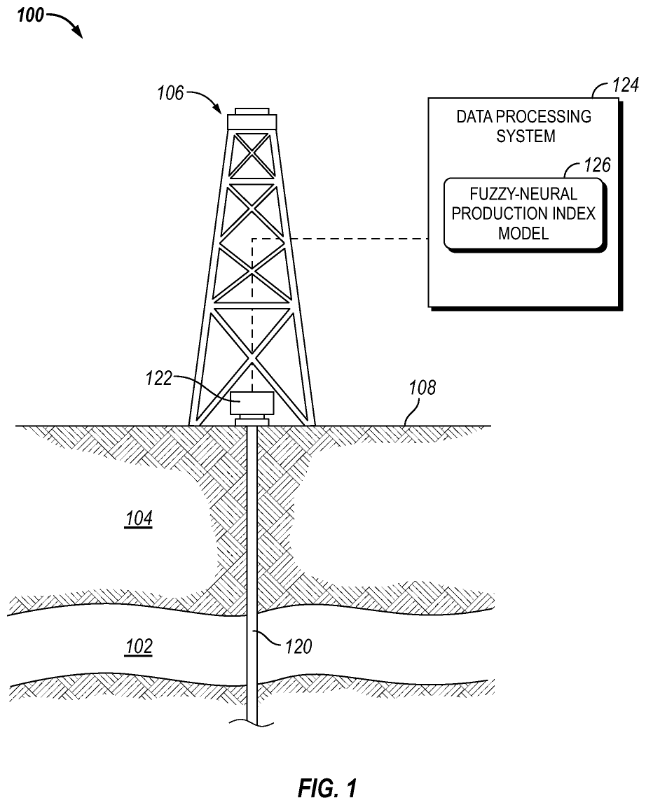

FIG. 1 is a diagram that illustrates a well environment 100 in accordance with an embodiment of the disclosure. In the illustrated embodiment, the well environment 100 includes a reservoir (“reservoir”) 102 located in a subsurface formation (“formation”) 104 and a well system (“well”) 106.

The formation 104 may include a porous or fractured rock formation that resides beneath the earth's surface (or “surface”) 108. The reservoir 102 may be a hydrocarbon reservoir defined by a portion of the formation 104 that contains (or that is at least determined or expected to contain) a subsurface pool of hydrocarbons, such as oil and gas. The formation 104 and the reservoir 102 may each include layers of rock having varying characteristics, such as varying degrees of permeability, porosity, and fluid saturation. In the case of the well 106 being operated as a producing well (also referred to as a “production” well), the well 106 may be a hydrocarbon producing well that is operable to facilitate the extraction of hydrocarbons (or “production”) from the reservoir 102.

The well 106 may include a wellbore 120, a production system 122, and a data processing system 124. The wellbore 120 may be, for example, a bored hole that extends from the surface 108 into a target zone of the formation 104, such as the reservoir 102. The wellbore 120 may be created, for example, by a drill bit of a drilling system of the well 106 boring through the formation 104 and the reservoir 102. An upper end of the wellbore 120 (for example, located at or near the surface 108) may be referred to as the “up-hole” end of the wellbore 120. A lower end of the wellbore 120 (for example, terminating in the formation 104) may be referred to as the “down-hole” end of the wellbore 120.

In some embodiments, the production system 122 includes production devices that facilitate that extraction of production from the reservoir 102 by way of the wellbore 120. For example, the production system 122 may include valves, pumps and sensors that are operable to regulate the flow of production from the wellbore 120 and to monitor production parameters (for example, production flow rate, temperature, and pressure). The sensors may include, for example, a flow rate sensor that is operable to sense a rate of the flow of production from the wellbore 120 (for example, to sense the production flow rate (q) of the well 106), a pressure sensor that is operable to sense pressure at an up-hole end of the wellbore 120 (for example, a wellhead pressure sensor that is operable to sense a wellhead pressure (WHP) of the well 106), a down-hole pressure sensor that is operable to sense pressure in a lower (or “down-hole”) portion of the wellbore 120 (for example, a bottom hole pressure (BHP) sensor that is operable to sense a bottom hole pressure (BHP) of the well 106), or a water cut sensor that is operable to sense water content of production flowing from the wellbore 120.

In some embodiments, the data processing system 124 is operable to receive various determinations from the well system 106, other well systems, or combinations thereof, and make various determinations. For example, the data processing system 124 may include a memory and a processor that capable of performing the various process described in the disclosure. Accordingly, the data processing system 124 may include a fuzzy-neural production index model 126 implemented according to the techniques of the disclosure. As described in the disclosure, the fuzzy-neural production index model 126 may be used to determine a production index associated with the well system 106.

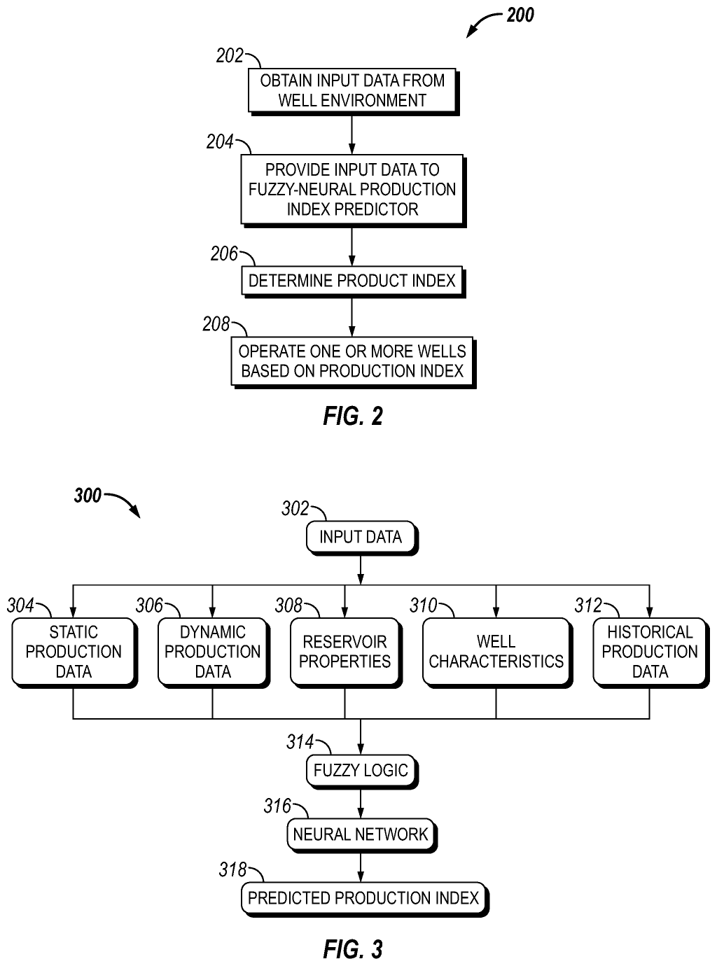

FIG. 2 is a flowchart that illustrates a process 200 for determining a production index of a hydrocarbon well in accordance with an embodiment of the disclosure. In the context of the well system 106, some or all of the operations of process 200 may be performed by the data processing system 124 (or another operator of the well system 106). As shown in FIG. 2, initially input data may be obtained from a well system (block 202). The input data may be provided to a fuzzy-neural production index model that uses fuzzy logic and neural network model (referred to as a “fuzzy-neural model”) and was trained in accordance with the techniques described in the disclosure (block 204). The production index for the well is then determined using the input data (block 206). After determining the production index, one or wells may be operated using the determined production index (block 208). For example, an operating parameter for the well may be determined and the well may be operated in accordance with this parameter. Such a parameter may include, for example, a flowrate of fluid (such as oil) or a setting on a valve (for example, percentage of opening of the valve).

Moreover, the predicted production index may be used in multiple applications. For example, the predicted production index may be used in reservoir management to improve reservoir development strategies, well placements, reservoir stimulation, and production optimization. The predicted production index may also be used in production forecasting and planning to improve allocation of resources. Additionally, the predicted production index may be used in enhanced oil recovery (EOR) by improved understanding of reservoir dynamics, resulting in increased oil recovery and production rates. The predicted production index may also be used in oilfield services for increased production efficiency and reduces operational costs. Further, the predicted production index may be used in wellbore design, such as for use in determining wellbore trajectories, and may also be used in hydraulic fracturing strategies to ensure efficient and cost-effective well operations. In some embodiments, the predicted production index may be provided as an input parameter to a reservoir simulation model for use in assessing the impact of different production strategies and for reserve estimation.

FIG. 3 is a block diagram 300 illustrating certain aspects of the process for determining a production index using a fuzzy-neural model in accordance with embodiment of the disclosure. FIG. 3 depicts the various types of input data 302 that may be provided to the fuzzy logic and neural network production index model. The input data 302 may include static production data 304, dynamic production data 306, reservoir properties 308, well characteristics 310, and historical production data 312.

In some embodiments, the static production data 304 may include reservoir size, reservoir location, properties of the production oil or gas (for example, oil viscosity), or any combination thereof. In some embodiments, the static production data 304 may include details about the well's infrastructure.

The dynamic production data 306 may include real-time operational data from a well. In some embodiments, the dynamic production data 306 may include the current output from a well, water cut, gas-oil ratio, bottom-hole pressure, or any combination thereof.

The reservoir properties 308 may include, for example, reservoir depth, porosity, permeability, pressure, temperature, oil saturation, or any combination thereof. The well characteristics 310 may include specifications for the well. In some embodiments, the well characteristics 310 may include well depth, diameter, casing type (for example, casing diameter), completion type, tubing size, well type, or any combination thereof. For example, well type may specify vertical well, horizontal well, or deviated well. In another example, completion type may be cased, cased and cemented, or cased gravel pack.

The historical production data 312 may include data that provides insights into future well behavior. In some embodiments, the historical production data 312 includes past production rates, past recovery percentage, or any combination thereof.

As shown in FIG. 3, the input data 302 (the static production data 304, dynamic production data 306, reservoir properties 308, well characteristics 310, and historical production data 312) may be processed via fuzzy logic 314. The output from the fuzzy logic 314 may be provided to a neural network 316. The neural network 316 may be trained on the data processed by the fuzzy logic, such that the neural network may recognize complex patterns and relationships between the different variables. The neural network may then output a predicted production index 316 that quantifies the productivity of a well. The production index may be used to gauge operational efficiency and develop strategies for optimal production from a reservoir.

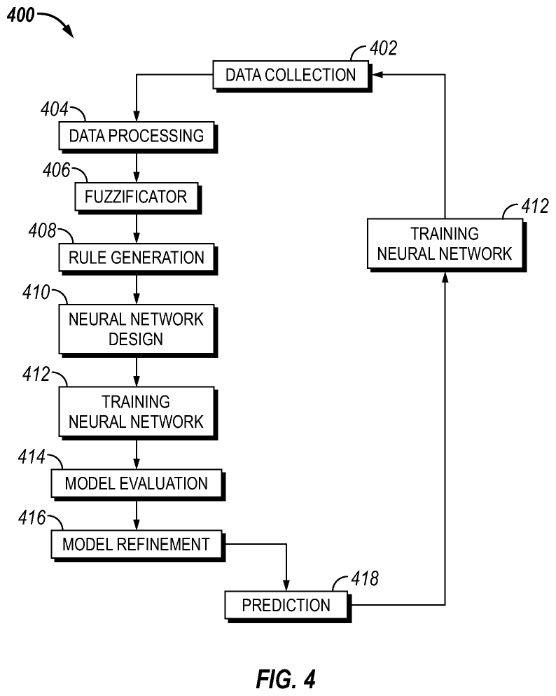

FIG. 4 is a flowchart of a process 400 for generating and using fuzzy-neural production index model in accordance with an embodiment of the disclosure. Initially, input data is collected (block 402). The input data may be obtained from one or more existing wells. As discussed infra and shown in FIG. 3, the input data may include both static and dynamic data. The input data may include any number of variables and respective values.

Next, the data is preprocessed (block 404). The preprocessing may include normalizing the data into format suitable for the fuzzy-neural model. In some embodiments, the preprocessing may include processing missing data, outliers, normalizing different scales of data to a standard range, or any combination thereof. In some embodiments, processing missing data may include filling in missing vales using an average value for a variable or using interpolation to estimate the missing values. In some embodiments, outliers may be deleted from the data, replaced with a median value, or replaced with a value based on domain knowledge or expert opinion. In some embodiments, data normalization may include transform all values of the input data to a common scale. In some embodiments, the common scale is 0 to 1.

In some embodiments, the preprocessing (block 404) may also include splitting the data into training sets and testing sets. In some embodiments, 80% of the data may be used for training the model and 20% of the data may be used for testing the model's performance. In some embodiments, 70% of the data may be used for training the model and 30% of the data may be used for testing the model's performance. Other embodiments may use different ratios of training data to testing data. As discussed in the disclosure, the training data may be used in the process 400 for training the fuzzy-neural model, while the testing data is used to test the trained model.

As shown in FIG. 4, the process 400 includes fuzzification (block 406) of the preprocessed data. As used herein, the terms “fuzzification” and “fuzzifying” refer to transforming the input data values into fuzzy values of fuzzy sets. The fuzzification includes defining fuzzy sets and membership functions for each input variable based on expert knowledge or data-driven techniques, such that the membership functions determine the degree to which each input variable belongs to each fuzzy set. In some embodiments, for example, a typical fuzzy set may be defined as “Low,” “Medium,” and “High,” although embodiments may include different fuzzy sets. Fuzzy membership may be defined by assigning a value using a linear or non-linear membership function for values of the input data for a fuzzy set.

Next, the process 400 includes rule generation (block 408) for the fuzzy inferences. The rule generation includes creating a rule base that describes the relationship between input variables and the output variable (that is, the production index). In some embodiments, a rule may include one or more IF statements (combined with an AND or OR) and a THEN statement with a resulting fuzzy value for production index.

Next, the process 400 includes designing the neural network (block 410). The neural network design may include determining the number of layers, number of neurons in each layer, activation functions, and other parameters of the neural network architecture. In some embodiments, the neural-network is a feed-forward neural network. In some embodiments, the neural network may include an input layer, one or more hidden layers, and an output layer. In some embodiments, the input layer may include a number of neurons corresponding to the number of input variables in the input layer. For example, for embodiments having three input variables, three neurons may be used in the input layer.

The number of hidden layers and the number of neurons in each layer may be determined through design and tuning. In some embodiments, the neural network may include one to five hidden layers. In some embodiments, each hidden layer may include three to seven neurons. The neurons in the hidden layers may use activation functions to introduce non-linearity into the model. In some embodiments, the activation functions may include ReLU (Rectified Linear Unit) or tanh (hyperbolic tangent).

The output layer may include one neuron corresponding to the output variable (production index). The output layer may include an activation function corresponding to the nature of the problem (for example, regression or classification). In some embodiments, the activation function for a regression problem may a linear activation function or an identity activation function.

After the neural network is designed, the neural network may be trained (block 412) using the fuzzy outputs from the rule base as the training data, enabling the neural network to learn to map the input variables to the production index. The fuzzy outputs of the rule base for the training data are used as the input for the neural network. It should be appreciated that the neural network of the fuzzy-neural model implicitly performs the defuzzification of the fuzzy outputs. Using the neural network, the fuzzy outputs are defuzzied to convert the fuzzy outputs into a discrete output value (that is, the production index).

The training (block 412) may include using a suitable learning algorithm (to adjust the weights and biases of the neural network during training to minimize the loss function. In some embodiments, the learning algorithm is gradient descent or backpropagation. In such embodiments, an initial set of weights and biases is randomly assigned, and then iteratively updated to minimize a loss function. In such embodiments, the loss function may be Mean Squared Error (MSE).

As shown in FIG. 4, the process 400 also includes evaluation of the fuzzy-neural model (block 414). The performance of the fuzzy-neural model be evaluated using the testing data. The evaluation may include metrics such as accuracy, precision, recall, F1-score, or other suitable metrics or combination thereof. In some embodiments, the metrics used to evaluate the prediction of the production index may include as Mean Absolute Error (MAE), Mean Squared Error (MSE), or Root Mean Squared Error (RMSE). These metrics are described in more detail in the EXAMPLES section discussed supra. The metrics may be determined by comparing the model's predicted production index values and the actual production index values in the testing dataset, such that lower values for the metrics would indicate better model performance. In some embodiments, the model's generalization ability (that is, its performance on new data) may be evaluated on cross-validation techniques or by having a separate validation dataset.

Next, the process 400 includes model refinement (block 416). Based on the evaluation, the fuzzy-neural model may be refined. The refinement may include, for example, adjusting the neural network architecture, tuning the hyperparameters, or updating the rule base of the fuzzy system. In such embodiments, the type of poor performance considered for refinement may result in different refinements to the model. In some embodiments, if the fuzzy-neural model is underfitting, then the neural network architecture may be adjusted, such as by increasing complexity by adding hidden layers, neurons in each layer, or both. In some embodiments, if the fuzzy-neural model is overfitting, then the hyperparameters of the model may be tuned. In such embodiments, the hyperparameters may be tuned to reduce the learning rate. Hyperparameters that may be adjusted may include the batch size, number of training iterations, or the type of optimizer used in the training phase. In some embodiments in which the fuzzy-neural model has a generally unsatisfactory performance, then the fuzzy rule based may be updated (block 824), such as by redefining fuzzy sets, adjusting membership functions, and modifying inference rules.

After the fuzzy-neural model is trained, evaluated, and refined, the fuzzy-neural model may be used to predict a production index (block 418) for new data from a well (as used herein, the term “new” data may refer to data previously unseen by the model). The predicted production index may be used to manage operation of the well, such as by operating valves to control production from the well.

Additionally, in some embodiments the process 400 includes iterative improvement (block 420) of the fuzzy-neural model. For example, the fuzzy-neural model may be iteratively improved to account for new production data, changes in reservoir properties due to the extraction of oil and gas and the natural processes occurring within the reservoir, and other factors. The iterative improvement may include retraining the neural network, updating the fuzzy rule base to adapt to changing dynamics, or a combination thereof.

Retraining the neural network may include processing production data in the same manner as the initial training data, beginning with preprocessing (block 402) the new production data. The fuzzy-neural model may then be trained on the preprocessed new production data, such that the network adjusts its weights and biases to better fit the new production data. Updating the fuzzy rule base may include changing fuzzy rules based on new knowledge. In some embodiments, for example, a specific reservoir property may exhibit a different impact on the production index than accounted for in the original fuzzy rules. In such embodiments, the fuzzy rules using that particular reservoir property may be updated.

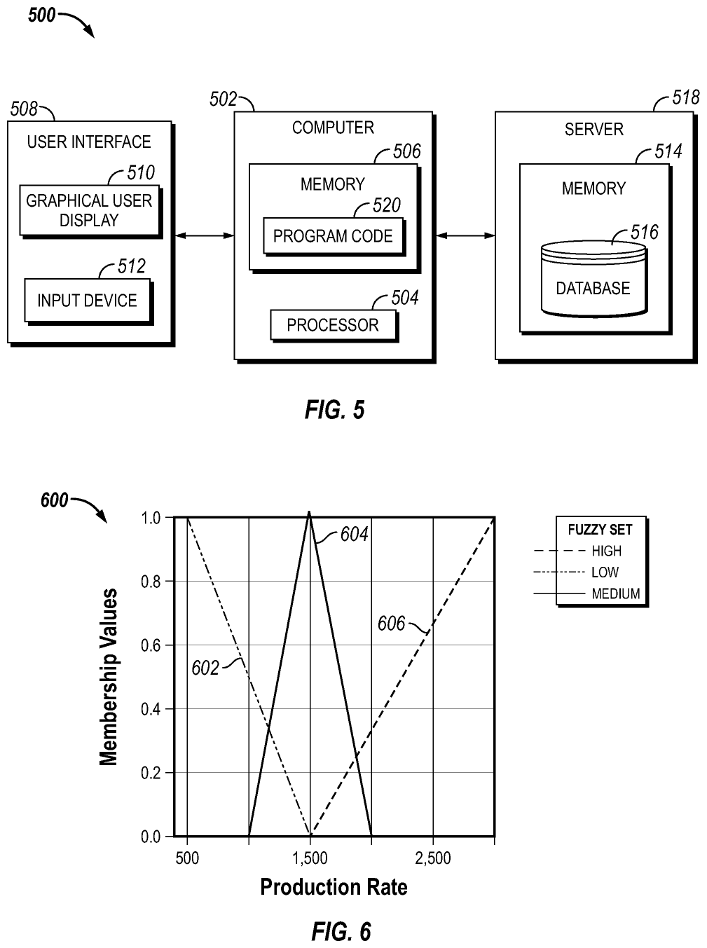

FIG. 5 depicts a data processing system 500 (such as the data processing system 124) that includes a computer 502 having a processor 504 and memory 506 coupled to the processor 504 to store operating instructions, control information and database records therein in accordance with an embodiment of the disclosure. The data processing system 500 may be a multicore processor with nodes such as those from Intel Corporation or Advanced Micro Devices (AMD), or an HPC Linux cluster computer. The data processing system 500 may also be a mainframe computer of any conventional type of suitable processing capacity such as those available from International Business Machines (IBM) of Armonk, N.Y., or other source. The data processing system 500 may in cases also be a computer of any conventional type of suitable processing capacity, such as a personal computer, laptop computer, or any other suitable processing apparatus. The data processing system 500 may also be representative of resources available in a computer cluster or a cloud-computing platform. It should thus be understood that a number of commercially available data processing systems and types of computers may be used for this purpose.

The computer 502 is accessible to operators or users through user interface 508 and are available for displaying output data or records of processing results obtained according to the present disclosure with an output graphic user display 510. The output display 510 includes components such as a printer and an output display screen capable of providing printed output information or visible displays in the form of graphs, data sheets, graphical images, data plots and the like as output records or images.

The user interface 508 of computer 502 also includes a suitable user input device or input/output control unit 512 to provide a user access to control or access information and database records and operate the computer 502. Data processing system 500 further includes a database of data stored in computer memory, which may be internal memory 506, or an external, networked, or non-networked memory as indicated at 514 in an associated database 516 in a server 518.

The data processing system 500 includes executable code 520 stored in non-transitory memory 224 of the computer 502. The executable code 520 according to the present disclosure is in the form of computer operable instructions causing the data processor 504 to receive input data and provide outputs based on processing the input data. The computer operable instructions of the executable code 520 may execute and train a fuzzy-neural model according to the techniques described herein, and may determine a production index using the trained fuzzy-neural model.

The executable code 520 may be in the form of microcode, programs, routines, or symbolic computer operable languages capable of providing a specific set of ordered operations controlling the functioning of the data processing system 500 and direct its operation. The instructions of executable code 520 may be stored in memory 506 of the data processing system 500, or on computer diskette, magnetic tape, conventional hard disk drive, electronic read-only memory, optical storage device, or other appropriate data storage device having a non-transitory computer readable storage medium stored thereon. Executable code 520 may also be contained on a data storage device such as server 518 as a non-transitory computer readable storage medium, as shown.

### EXAMPLES

The following examples are included to demonstrate embodiments of the disclosure. It should be appreciated by those of skill in the art that the techniques and compositions disclosed in the example which follows represents techniques and compositions discovered to function well in the practice of the disclosure, and thus can be considered to constitute modes for its practice. However, those of skill in the art should, in light of the present disclosure, appreciate that many changes can be made in the specific embodiments which are disclosed and still obtain a like or a similar result without departing from the spirit and scope of the disclosure.

### Example Process for Production Index Prediction Using a Fuzzy-Neural Model

An example oilfield with multiple wells will be described with reference to process 400 of FIG. 4. For the initial data collection (block 402), the following static data may be collected:

### Reservoir Properties for Well 1:

Reservoir Depth: 8000 feet;
Reservoir Pressure: 3600 psi;
Reservoir Temperature: 220° F.;
Porosity: 20%;
Permeability: 76 millidarcies (mD); and
Oil Saturation: 66%;

### Well Characteristics for Well 1:

Well Diameter: 8; 6 inches;
Casing Type: 7″ casing;
Completion Type: cased hole gravel pack completion;
Tubing Size: 2⅞″ for Well 1; and
Well type: horizontal well;

The following example dynamic data may be collected:

### Production History for Well 1:

Production Rate: started with a production rate of 2000 barrels per day, which declined to 1800 barrels after one month, 1600 barrels after two months, and so on;
Water Cut: started at 20% and increased to 26% after six months;
Gas-Oil Ratio: started at 600 standard cubic foot per stock tank barrel (scf/stb) and gradually increased over time; and
Bottom-Hole Pressure: The bottom-hole pressure decreased over time as production continued;

This data may be collected for all the wells in the example oilfield and compiled into a comprehensive dataset for further processing and analysis. The dynamic data may be time-series data with measurements taken at regular intervals, such as daily or monthly.

Assuming that the data was collected from multiple wells in the example oilfield over a time period and then collated into a dataset, the data may then be preprocessed (block 404). The following example preprocessing steps may be performed:

Handle Missing Data: the production rate for Well 1 is missing for some days. In one example, the missing values may be filled with the average production rate of Well 1. In another example, interpolation could be used to estimate the missing values based on the values from adjacent time points.

Handle Outliers: Well 2 has an abnormally high production rate for a particular day, which seems like a measurement error. In one example, the outlier may be replaced with a median value. In another example, the outlier may be replaced based on domain knowledge or expert opinion.

Normalization: The collected data will be on different scales. For instance, reservoir depth might be in the order of thousands of feet, while porosity may be a percentage between 0 and 1. Min-max normalization may be applied to transform all values to a common scale between 0 and 1. By way of example, if the reservoir depth ranges from 6000 to 9000 feet, after normalization, a depth of 8000 feet would be transformed as follows in Equation 1:

$$Normalized\_Depth = ( 8000 - 6000 ) / ( 9000 - 6000 ) = 0.76 \qquad ( 1 )$$

Other variables may be normalized in a similar manner.

As discussed infra, the preprocessing may also include diving the data into training and testing sets. In one example, 80% of the data may be used for training the model and 20% of the data may be used for testing the model's performance. Data may be shuffled to ensure a random distribution and then divided into the testing and training sets. For example, for a dataset of 1000 data points, the first 800 may be used for training the model and the remaining 200 may be used for testing the model.

Next, the data may be under fuzzification (block 406). As discussed infra, the fuzzification includes defining fuzzy sets and membership functions for each input variable, such that the membership functions determine the degree to which each input variable belongs to each fuzzy set. The production rate of the well is an input variable used in the example and may be assumed to range from 600 barrels per day to 3000 barrels per day after normalization. For this example input variable, three fuzzy sets may be defined: “Low,” “Medium,” and “High.” The boundaries and the membership functions for these sets may be determined based on expert knowledge or data-driven methods. In one example, the sets may be defined as follows:

Low Production Rate: A fuzzy set that captures production rates from 600 to 1600 barrels per day. The membership function may be defined such that it gives a membership value of 1 (full membership) for rates at 600 barrels per day and decreases linearly to a membership value of 0 (no membership) at 1600 barrels per day.

Medium Production Rate: A fuzzy set for production rates from 1000 to 2000 barrels per day. The membership function for this set may be defined as a triangular function, with a membership value of 0 at 1000 barrels per day, increasing linearly to 1 at 1600 barrels per day, and then decreasing linearly to 0 at 2000 barrels per day.

High Production Rate: A fuzzy set for production rates from 1600 to 3000 barrels per day. The membership function for this set may be defined such that it gives a membership value of 0 at 1600 barrels per day and increases linearly to 1 at 3000 barrels per day.

FIG. 6 is a graph 600 of the “Low,” “Medium,” and “High” fuzzy sets discussed infra in accordance with an embodiment of the disclosure. The graph defines membership value on the y-axis vs. production rate on the x-axis. As shown in FIG. 6, each fuzzy set is depicted by a corresponding line in the graph 600: Low (line 602), Medium (line 604), and High (line 606).

For example, for an oil well having a production rate of 1600 barrels per day, the fuzzy sets based on the example membership functions may be as follows:
Low membership value in the ‘Low Production Rate’ set (approximately 0);
Medium membership value in the ‘Medium Production Rate’ set (approximately 0.8); and
Low membership value in the ‘High Production Rate’ set (approximately 0.2).

Next, rules may be generated (block 408) for the example data to dictate the relationships between the input variables and the output variable (production index). For example, for three input variables (and corresponding fuzzy sets) of production rate (Low, Medium High), reservoir porosity (Low, High), and water cut (Low, High), and an output variable of production index (Low, Medium, High), an example rule base may be as follows:
IF (Production Rate is Low) AND (Porosity is Low) AND (Water Cut is High) THEN (Production Index is Low);
IF (Production Rate is Low) AND (Porosity is High) AND (Water Cut is Low) THEN (Production Index is Medium);
IF (Production Rate is Medium) AND (Porosity is Low) AND (Water Cut is High) THEN (Production Index is Medium);
IF (Production Rate is Medium) AND (Porosity is High) AND (Water Cut is Low) THEN (Production Index is High); and
IF (Production Rate is High) AND (Porosity is High) AND (Water Cut is Low) THEN (Production Index is High).

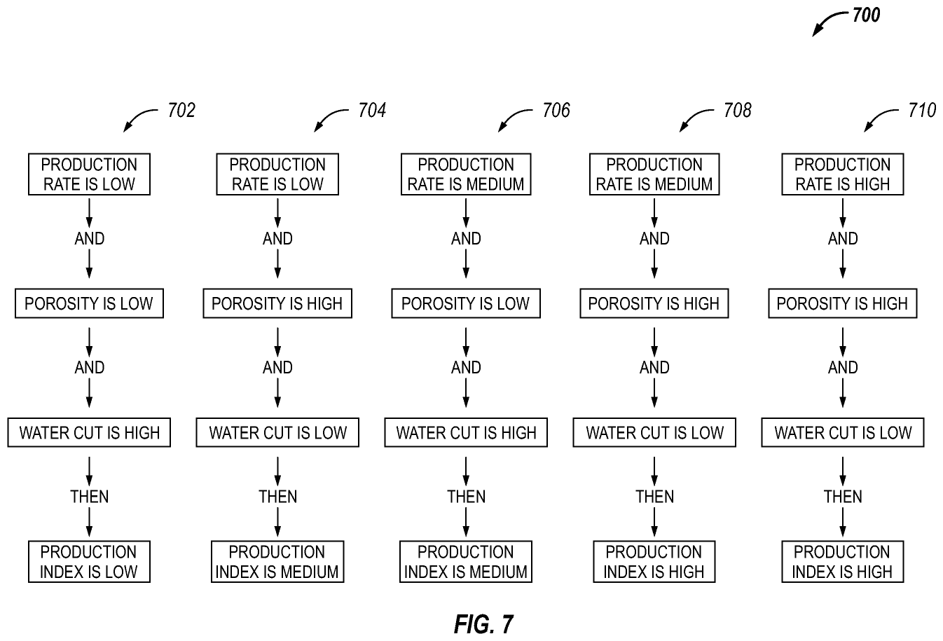

FIG. 7 is a flowchart 700 summarizing this example rule base in accordance with an embodiment of the disclosure. FIG. 7 is a graphical depicting of five rules 702, 704, 707, 708, and 710 that correspond to the five example rules discussed infra. For example, as shown in FIG. 7, rule 702 states that if the production rate and reservoir porosity are low, and the water cut is high, then the production index is predicted to be low. In another example, rule 704 states that if the production rate is low, the reservoir porosity is high, and the water cut is low, then the production index is predicted to be medium. For each new data point, the degree of match with each rule is evaluated and the appropriate fuzzy output is generated for each rule. Using the neural network, the fuzzy output is defuzzied to convert the fuzzy output into a discrete output value (that is, the production index).

The next step in the example is designing a neural network (block 410). In this example, a feed-forward neural network is designed having an input layer, hidden layers, and an output layer, as follows:
Input Layer: The input layer consists of neurons corresponding to the number of input variables. In the example having three input variables—Production Rate, Reservoir Porosity, and Water Cut—there would be three neurons in the input layer;
Hidden Layers: The number of hidden layers and the number of neurons in each layer may be determined through experimentation and tuning. As a starting point in the example, two hidden layers are used each containing five neurons. The neurons in these layers would utilize activation functions to introduce non-linearity into the model. Such functions may include the ReLU (Rectified Linear Unit) or tanh (hyperbolic tangent); and
Output Layer: Finally, the output layer will have a single neuron, representing the production index, the target variable. Depending upon the nature of the problem (regression or classification), an appropriate activation function is chosen. For regression problems, in some embodiments a linear or identity activation function may be used.

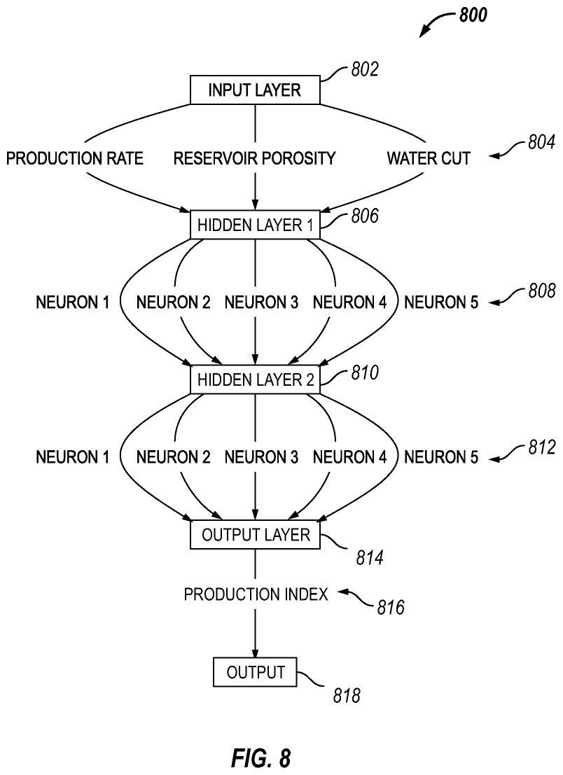

FIG. 8 depicts the neural network structure 800 described supra in accordance with an embodiment of the disclosure. In this example, the input layer 802 include three neurons 804 corresponding to three input variables—Production Rate, Reservoir Porosity, and Water Cut. The first hidden layer 806 includes five neurons 808, and the second hidden layer 810 includes five neurons 812. The output layer 814 includes one neuron 816 corresponding to the target variable production index which results in the final output 818 of the model. This structure may be identified as [3-6-6-1].

As shown in FIG. 4, the next step in the example is training the neural network (block 412) so that the neural network learns to map the input variables to the production index as guided by the fuzzy outputs from the rule base. The fuzzy outputs of the rule base for the training data are used as the input for the neural network. In this example, a gradient descent algorithm is used to train the neural network.

In gradient descent, an initial set of weights and biases is randomly assigned, and then iteratively updated to minimize a loss function. The loss function quantifies the discrepancy between the actual production index and the neural network's prediction. For example, mean squared error (MSE) may be used as the loss function and is defined as follows:

$$L = 1 / n \sum {( y\_actual - y\_predicted )}^{2} \qquad ( 2 )$$

Where L is the MSE loss function, y_actual is the actual production index, y_predicted is the predicted production index output by the neural network, and n is the number of data points.

At each step in the training process, the gradient of the loss function with respect to the weights and biases is calculated. This gradient indicates the direction of steepest ascent; thus, to minimize the loss want to minimize the loss, the process moves in the opposite direction (that is, the direction of steepest descent). This process is repeated until the loss function reaches a minimum value or until a predetermined number of iterations are completed. This iterative learning process allows the network to adjust its weights and biases to better predict the production index from the given inputs, providing an accurate, robust, and nuanced model for production index prediction.

After the training phase, the fuzzy-neural model is evaluated (block 414). The trained fuzzy-neural model's performance is evaluated using the testing data which the model has not seen before.

In this example, metrics used to evaluate the prediction of the production index, a continuous variable, may include as Mean Absolute Error (MAE), Mean Squared Error (MSE), or Root Mean Squared Error (RMSE). These metrics allow evaluation of the average difference between the predicted and actual values of the production index and may be summarized as follows:

Mean Absolute Error (MAE): This is the average of the absolute differences between the predicted and actual values. It gives a measure of the magnitude of the error, without considering the direction and may be determined according to the following:

$$MAE = 1 / n \sum \vert y\_actual - y\_predicted \vert \qquad ( 3 )$$

Mean Squared Error (MSE): This is the average of the squares of the differences between the predicted and actual values. MSE gives more weight to larger errors due to squaring, which can be desirable when larger errors are particularly undesirable. MSE may be determined as follows:

$$MSE = 1 / n \sum {( y\_actual - y\_predicted )}^{2} \qquad ( 4 )$$

Root Mean Squared Error (RMSE): This is the square root of the MSE. It has the same units as the output variable, making it somewhat more interpretable than the MSE. RMSE may be determined as follows:

$$RMSE = sqrt ( MSE ) \qquad ( 5 )$$

Using the example data, the metrics would be determined by comparing the model's predicted production index values and the actual production index values in the testing dataset. Lower values for these metrics would indicate better model performance. In some instances, the model's generalization ability (that is, its performance on new data) may be evaluated on cross-validation techniques or by having a separate validation dataset.

In this example, if the model performs well in the evaluation phase, it may be deemed ready for deployment. If the model does not perform well, the model architecture, hyperparameters, or data preprocessing may be adjusted to improve the model's performance.

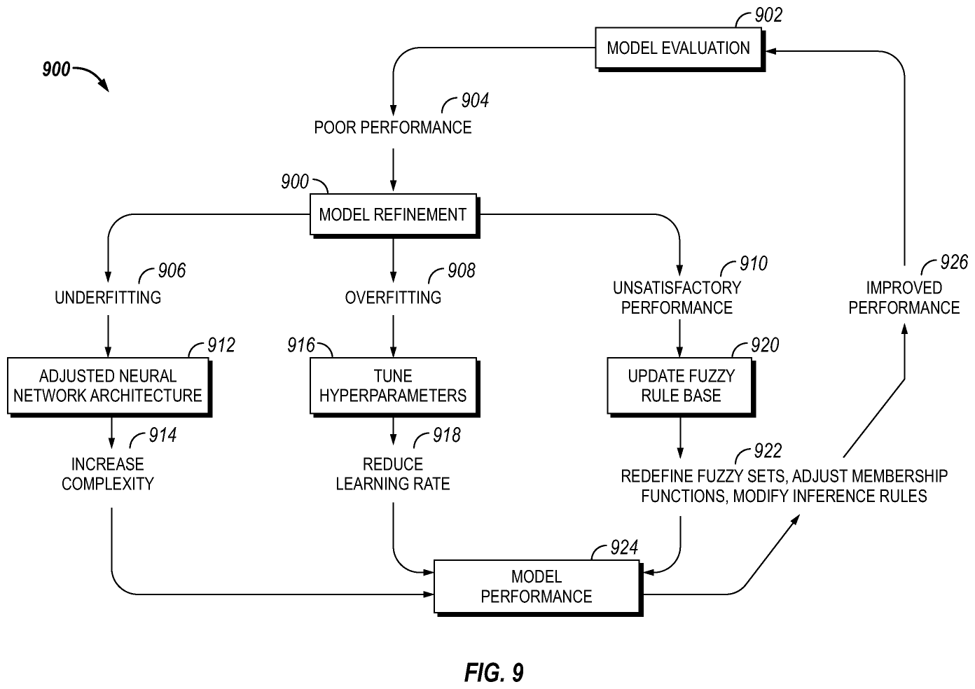

Based on the model evaluation, the model may be refined (block 416), such as by adjusting the architecture of the neural network, tuning the hyperparameters, or updating the rule base of the fuzzy system. FIG. 9 is a flowchart depicting an example of model refinement 900 with feedback loops in response to model evaluation 902 in accordance with an embodiment of the disclosure. As shown in FIG. 9, a model evaluation 902 indicating poor performance 904 may require model refinement 900. The model refinement may be based on various types of poor performance, such as underfitting 906, overfitting 908, and unsatisfactory performance 910. If the model is underfitting, then the neural network architecture may be adjusted (block 912), such as by increasing complexity 914. If the model is overfitting, then the hyperparameters of the model may be tuned (block 916) to reduce the learning rate 918. If the model has unsatisfactory performance, then the fuzzy rule based may be updated (block 920), such as by redefining fuzzy sets, adjusting membership functions, and modifying inference rules (block 922).

As shown in FIG. 9, the various model refinements may be used to affect model performance (block 924) and may result in improved performance 926 when another model evaluation is performed.

Examples of model refinement are provided as follows:
Adjusting the Neural Network Architecture: In one example, poor performance by the model on the test set may indicate that the model is underfitting the data. This could mean that the neural network's architecture is too simple to capture the complex relationship between the input variables and the production index. In this example, the complexity of the neural network may be increased, such as by adding more layers or neurons in each layer.
Tuning the Hyperparameters: In another example, good performance on the training data but poor performance on the testing may indicate overfitting. This could mean that the learning rate is too great, causing the model to fit the training data too closely and not generalize well to new data. In this example, the learning rate may be reduced. Other hyperparameters that may be adjusted include the batch size, the number of training iterations, or the type of optimizer used in the training phase.
Updating the Rule Base of the Fuzzy System: In another example, if the model's performance is unsatisfactory, the rule base of the fuzzy system may be modified. The rule base essentially determines how the input variables are transformed into the fuzzy output, which is then used as the training data for the neural network. If this transformation is not capturing the underlying relationship accurately, the neural network will have difficulty learning to predict the production index. In example case, the fuzzy sets may be redefined, the membership functions adjusted, or the inference rules modified.

In each example, the bias-variance trade-off may be considered. The fuzzy-neural model may be complex enough to capture the underlying relationship (reduce bias), but not so complex that it fits the noise in the data (increase variance)

After the model is trained, evaluated, and refined, the model may be used to predict the production index for new data (block 418). Further, the fuzzy-neural model may be iteratively improved (block 420) to ensure the longevity and reliability of the model for production index prediction. In the existing example, a significant amount of new production data may be generated after using the model for several months. Additionally, reservoir properties may have changed due to the extraction of oil and gas and the natural processes occurring within the reservoir. The accuracy of the model may be maintained by incorporating this information. The iterative improvement may include retraining the neural network and updating the fuzzy rule base:

Retraining the Neural Network: The new data may be preprocessed in the same manner as the initial dataset. The preprocessed data would then be used to retrain the neural network, such that the network adjusts its weights and biases to better fit the new dataset.

Updating the Fuzzy Rule Base: The fuzzy rule base was initially created based on expert knowledge and the original dataset. With the acquisition of new data and potentially new insights, the rule base may be updated. For example, if a specific reservoir property has a different impact on the production index than initially considered, the corresponding fuzzy rules may be updated to reflect the new impact.

Continually updating and improving the fuzzy-neural model ensures that the model will remains a valuable tool for predicting the production index, contributing to efficient and effective decision-making. The combination of the neural network's ability to capture complex relationships and the fuzzy logic algorithm's capability to handle uncertainties and imprecision, embodiments of the disclosure offer an improved fitting accuracy for predicting the production index. Moreover, such embodiments consider both static and dynamic production data, providing a more comprehensive and accurate prediction method for the complex factors affecting production index dynamics in the oilfield industry.

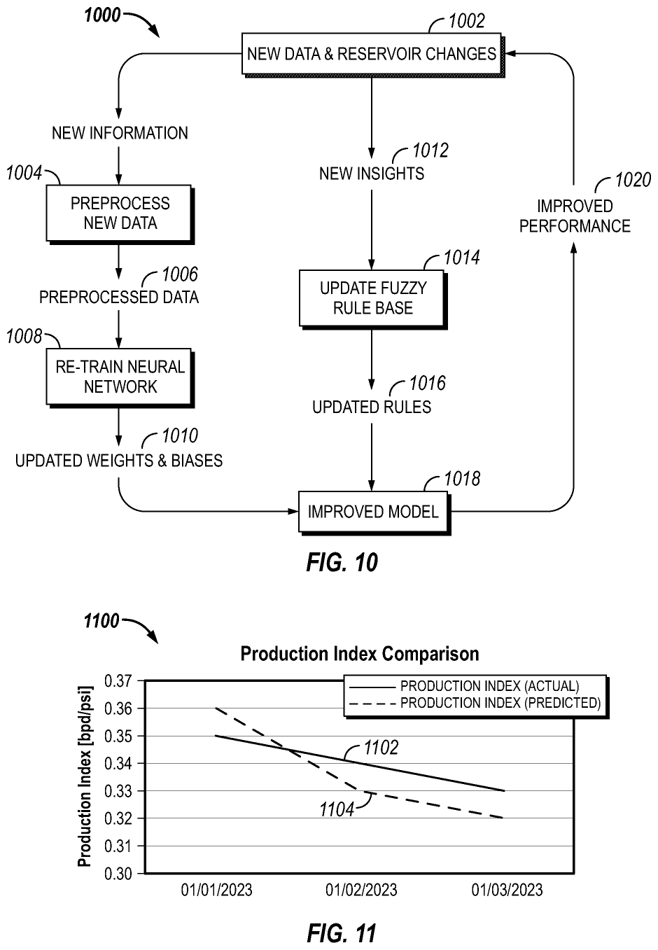

FIG. 10 is a flowchart depicting the iterative improvement 1000 of a fuzzy-neural model in accordance with an embodiment of the disclosure. For example, new data and reservoir changes (block 1002) may be obtained after operation of an existing fuzzy-neural model. The new data 1002 may be preprocessed (block 1004) in the manner described in the disclosure to obtain preprocessed new data 1006. The preprocessed new data 1006 may be used to retrain the neural network (block 1008) resulting in updated weights and biases 1010.

As also shown in FIG. 10, the new data and changes in the reservoir may produce new insights 1012 related to the input data and its interaction with these properties. The fuzzy rule base may be updated (block 1014) to create updated rules (block 1016). The updated weights and biases (block 1010) and updated rules (block 1016) may result in an improved fuzzy-neural model 1018 having improved performance 1020.

### First Example Input Data for Production Index Prediction Using a Fuzzy-Neural Model

Table 1 depicts an example real-world dataset collected from oil reservoirs and production systems that may be used as an input data in embodiments of the disclosure:

TABLE 1
EXAMPLE REAL-WORLD DATASET

| | | | | | | | Cumulative | |
|---|---|---|---|---|---|---|---|---|
| | | | | Oil | | Average | Oil | |
| Well | Reservoir | Porosity | Permeability | Viscosity | Water | Pressure | Produced | Production |
| ID | Depth (ft) | (%) | (mD) | (cp) | Cut (%) | (psi) | (bbl) | Index |
| 1 | 8500 | 20 | 120 | 10 | 40 | 2000 | 15000 | 0.3 |
| 2 | 9000 | 22 | 150 | 15 | 45 | 2100 | 18000 | 0.4 |
| 3 | 9500 | 23 | 130 | 14 | 42 | 2050 | 17500 | 0.35 |
| 4 | 9000 | 19 | 110 | 12 | 48 | 2100 | 16000 | 0.32 |
| 5 | 9200 | 21 | 140 | 13 | 41 | 2200 | 18500 | 0.37 |

In Table 1, the following variables are listed:
Reservoir Depth—the depth of the oil reservoir below the surface;
Porosity—the measure of void spaces in the reservoir rock where oil and gas could be stored;
Permeability—the ability of the reservoir rock to transmit fluids;
Oil Viscosity—the ease with which oil can flow through the rock;
Water Cut—the ratio of water produced along with oil;
Average Pressure—the average reservoir pressure;
Cumulative Oil Produced—the total amount of oil produced from the well till the time of data collection; and
Production Index—the measure of the well's productivity, calculated as the oil production rate divided by the drawdown pressure.

### Second Example Input Data for Production Index Prediction Using a Fuzzy-Neural Model

Table 2 depicts another example real-world dataset collected from oil reservoirs and production systems that may be used as an input data in embodiments of the disclosure:

TABLE 2
EXAMPLE REAL-WORLD DATASET

| | | | | | | | | | Average | Cumulative | | |
|---|---|---|---|---|---|---|---|---|---|---|---|---|
| | | | | Oil | Gas-Oil | Oil | Formation | | Reservoir | Oil | | |
| Well | Reservoir | Porosity | Permeability | Gravity | Ratio | Viscosity | Volume | Water | Pressure | Produced | Production | Production |
| ID | Depth (ft) | (%) | (mD) | (API) | (scf/bbl) | (cp) | Factor | Cut (%) | (psi) | (bbl) | Method | Index |
| 1 | 8000 | 15 | 100 | 28 | 600 | 8 | 1.2 | 30 | 1800 | 150000 | Natural | 0.3 |
| 2 | 9000 | 20 | 130 | 32 | 800 | 10 | 1.4 | 35 | 2000 | 180000 | EOR | 0.4 |
| 3 | 10000 | 25 | 120 | 30 | 700 | 9 | 1.3 | 32 | 1900 | 175000 | Pumping | 0.35 |
| 4 | 9500 | 18 | 110 | 29 | 650 | 9 | 1.25 | 33 | 1950 | 160000 | Natural | 0.32 |
| 5 | 8500 | 22 | 140 | 31 | 750 | 8 | 1.35 | 31 | 1850 | 185000 | EOR | 0.37 |

In addition to the variables listed Table 1, Table 2 also includes the following:
Oil Gravity (API)—a measure of how heavy or light petroleum liquid is compared to water. Lighter oils generally have a higher production index.
Gas—Oil Ratio (scf/bbl)—the volume of gas produced per barrel of oil. A higher ratio might indicate depletion and lower productivity.
Formation Volume Factor—accounts for the change in volume that oil undergoes from the reservoir conditions to surface conditions.
Average Reservoir Pressure—the pressure in the reservoir that pushes the oil towards the wellbore.
Production Method—how the oil is extracted, such as natural flow, pumping, or Enhanced Oil Recovery (EOR) techniques like water flooding or gas injection.

### Example Production Index Prediction Using Historical Real Data

A set of historical real-world data was used in an embodiment of the disclosure according to the process 400 depicted in FIG. 4. The data was normalized to a range of 0 to 1. The designed neural network had two hidden layers. The training of neural network used backpropagation and gradient descent. The data was separated into training and validation subsets to assess the performance of the fuzzy-neural model and avoid overfitting.

The fuzzy-neural model's performance was evaluated using Mean Absolute Error (MAE) between the predicted and actual production indices. Based on the evaluation, the model's learning rate and number of neurons were adjusted to optimize the model's performance.

After training the model, the MAE between the predicted and actual production indices for the validation data was found to be 0.06, indicating a relatively good fit. The model was further optimized by adjusting the learning rate and number of neurons, resulting in a reduced MAE of 0.03.

The real-world test data and model output is shown in Table 3. The “Production Index (Actual)” column contains the actual observed production index for the well, and the “Production Index (Predicted)” column contains the production index predicted by the fuzzy-neural system:

TABLE 3
REAL-WORLD DATASET AND MODEL OUTPUT

| | | | | | | | | | | Cumu- | | |
|---|---|---|---|---|---|---|---|---|---|---|---|---|
| | | | | | Gas- | Oil | | | Average | lative | Produc- | Produc- |
| | | Poros- | Perme- | Oil | Oil | Vis- | Formation | Water | Reservoir | Oil | tion | tion |
| | Reservoir | ity | ability | Gravity | Ratio | cosity | Volume | Cut | Pressure | Produced | Index | Index |
| Date | Depth (ft) | (%) | (mD) | (API) | (scf/bbl) | (cp) | Factor | (%) | (psi) | (bbl) | (Actual) | (Predicted) |
| Jan. 1, 2023 | 8500 | 18 | 120 | 30 | 700 | 8 | 1.3 | 32 | 1900 | 175000 | 0.35 | 0.36 |
| Jan. 2, 2023 | 8500 | 18 | 120 | 30 | 700 | 8 | 1.3 | 33 | 1900 | 177000 | 0.34 | 0.33 |
| Jan. 3, 2023 | 8500 | 18 | 120 | 30 | 700 | 8 | 1.3 | 34 | 1900 | 179000 | 0.33 | 0.32 |

The performance of the fuzzy-neural model may be evaluated by comparing the “Production Index (Actual)” column and the “Production Index (Predicted)” column. FIG. 11 is a graph 1100 of the Production Index (Actual) 1102 and the Production Index (Predicted) 1104 from Table 3 in accordance with an embodiment of the disclosure. The graph 1100 depicts Production Index on the y-axis and date on the x-axis.

Comparison of the Fuzzy-Neural Production Index Model with Other Techniques

The fuzzy-neural model described in the disclosure was compared with other techniques for determining production index from available reservoir pressure (Pr) and wellbore pressure (Pwf) for three real-world wells A1, A2, and A3. The three techniques for comparison were 1) Darcy's Law-Based Calculation; 2) Empirical Correlations; and 3) Standard Neural Network.

### 1. Darcy's Law-Based Calculation.

Darcy's law is a fundamental equation for fluid flow through porous media. The simplified formula for PI using Darcy's law is:

$$PI = \frac{k}{μ \times ( P r - Pwf )} \qquad ( 6 )$$

Where k is the permeability of the reservoir rock and u is the viscosity of the fluid. The results of the Darcy's law based calculation for a constant permeability k=100 mD and viscosity μ=1 centipoise (cP) for all wells is shown in Table 4:

TABLE 4
RESULTS OF DARCY'S
LAW BASED CALCULATION

| Well | PI (Darcy) |
|---|---|
| ID | [bbl/day/psi] |
| A1 | 4 |
| A2 | 4.1 |
| A3 | 4.2 |

### 2. Empirical Correlations

Empirical correlations are based on field data and are often used for specific reservoir conditions. The example empirical correlation for estimating PI used is as follows:

$$P I = a \times Q + b \times ( P r - Pwf ) \qquad ( 7 )$$

Where a and b are empirically derived constants. Assuming a=0.008 and b=0.002, the results of the empirical correlations are shown in Table 5:

TABLE 5
RESULTS OF
EMPIRICAL CORRELATIONS

| Well | PI (Empirical) |
|---|---|
| ID | [bbl/day/psi] |
| A1 | 4.6 |
| A2 | 4.6 |
| A3 | 4.7 |

### 3. Standard Neural Network

A standard neural network was trained on similar data. The predictions from the trained neural network are shown in Table 6:

TABLE 6
RESULTS OF STANDARD
NEURAL NETWORK

| | PI (Neural |
|---|---|
| Well | Network) |
| ID | [bbl/day/psi] |
| A1 | 4.8 |
| A2 | 4.9 |
| A3 | 6 |

The results of the production index prediction using the fuzzy-neural model according to the techniques of the present disclosure are shown in Table 7 with comparison to the other solutions:

TABLE 7
RESULTS FUZZY-NEURAL MODEL
COMPARED WITH OTHER SOLUTIONS

| Well | PI (Fuzzy- | PI | PI | PI (Neural |
|---|---|---|---|---|
| ID | Neural) | (Darcy) | (Empirical) | Network) |
| A1 | 6 | 4 | 4.6 | 4.8 |
| A2 | 6 | 4.1 | 4.6 | 4.9 |
| A3 | 6.6 | 4.2 | 4.7 | 6 |

As shown in Table 7 the fuzzy-neural model produces greater production index (PI) values for all wells as compared to the other three solutions. This may indicate the fuzzy-neural model is capturing some nuances or complexities in the data that the other solutions are missing.

The fuzzy-neural model was used with another set of input data and compared to other techniques. Three input variables were used:
Reservoir Pressure (P) in psi: 3000, 3200, 3400;
Permeability (k) in mD: 160, 176, 200; and
Viscosity (μ) in cP: 1, 1.2, 1.4.

The fuzzification of these input variables used the following membership functions:
Pressure: Low, Medium, High;
Permeability: Low, Medium, High; and
Viscosity: Low, Medium.

A rule base was defined based on expert knowledge. Two example rules included:
IF (P is High) AND (k is High) AND (μ is Low) THEN (PI is Very High); and
IF (P is Medium) AND (k is Medium) AND (μ is Medium) THEN (PI is Medium).

Using the input data and the rule base, fuzzy output values were determined then defuzzied and fed to a neural network. The neural network was trained using historical data having known production index values. The production index values for the input variables were as follows:
(3000 psi, 160 mD, 1 cP)->PI=0.72;
(3200 psi, 176 mD, 1.2 cP)->PI=0.78; and
(3400 psi, 200 mD, 1.4 cP)->PI=0.81.

The production index (PI) determinations were compared to a conventional deterministic model that typically uses reservoir and fluid properties to estimate production index. The deterministic model is defined as follows:

$$PI = \frac{P * k}{μ} \qquad ( 8 )$$

Where P is reservoir pressure in psi, k is permeability in mD, and u is viscosity in CP. The deterministic model calculates the production index as follows:
(3000 psi, 160 mD, 1 cP)->PI=460,000;
(3200 psi, 176 mD, 1.2 cP)->PI=466,667; and
(3400 psi, 200 mD, 1.4 cP)->PI=486,714.

The production indices determined using the fuzzy-neural model are normalized to 1 and should be scaled to the same range as the deterministic model for comparison. As shown in the production index values infra, the fuzzy-neural model produces a greater production index (PI) value than the deterministic model for a given data point. This indicates that the fuzzy-neural model may be capturing more complex interactions between the input parameters, leading to a more accurate prediction.

The production index determined by the fuzzy-neural model were also compared against decline curve analysis, another convention technique for determining production index. Decline curve analysis uses historical production data to predict future performance. An exponential decline curve is shown as follows:

$$PI = PI 0 e - Dt \qquad ( 9 )$$

Where PI0 is the initial production index, D is the decline rate in fraction per year, and t is time in years. The comparison was performed using a PI0 of 600,000, a decline rate D of 0.1 (10% per year) and a time t of 1 year. The exponential decline curve calculates the production index (PI) as follows:
(3000 psi, 160 mD, 1 cP)->PI=462,419;
(3200 psi, 176 mD, 1.2 cP)->PI=462,419; and
(3400 psi, 200 mD, 1.4 cP)->PI=462,419.

The decline curve model provides the same production index for all data points as it based on historical production data and does not consider reservoir properties. The comparison between the fuzzy-neural model and the is shown in Table 9:

Here again, the fuzzy-neural model produces a greater production index (PI) value than the decline curve model for a given data point. This further indicates that the fuzzy-neural model may be capturing the intricacies of reservoir properties and their impact on production.

Comparison of the Fuzzy-Neural Production Index Model with Commercial Solutions

A fuzzy-neural model according to the present disclosure was compared against three existing commercial solutions using real-world datasets from five wells. The existing commercial solutions are identified as Model A, Model B, and Model C. The dataset of parameters that could influence the production index (PI), the actual production index, and the production indices determined by the fuzzy-neural model (FNI), Model A, Model B, and Model C are shown in Table 8:

TABLE 8
PARAMETER DATASET AND PRODUCTION INDICES

| | Reservoir | | | | Actual PI | FNI | Model A | Model B | Model C |
|---|---|---|---|---|---|---|---|---|---|
| Well | Pressure | Permeability | Viscosity | Water | (bbl/day/ | Predicted | Predicted | Predicted | Predicted |
| ID | (psi) | (mD) | (cP) | Cut (%) | psi) | PI | PI | PI | PI |
| W1 | 3000 | 150 | 1.5 | 10 | 2 | 2.1 | 2.3 | 2.4 | 2.2 |
| W2 | 3200 | 130 | 1.6 | 15 | 1.8 | 1.7 | 1.9 | 2 | 1.9 |
| W3 | 2900 | 140 | 1.4 | 12 | 1.9 | 1.8 | 2 | 2.1 | 2 |
| W4 | 3100 | 155 | 1.5 | 11 | 2.1 | 2.2 | 2.4 | 2.5 | 2.3 |
| W5 | 3050 | 145 | 1.7 | 14 | 1.7 | 1.6 | 1.8 | 1.9 | 1.8 |

As shown in Table 8 and as discussed further supra, the fuzzy-neural model provides a more accurate production index (PI) than the existing commercial solutions.

To evaluate the comparison, the Mean Absolute Error (MAE) and Root Mean Square Error (RMSE) were calculated for the fuzzy-neural model (FNI), Model A, Model B, and Model C, as shown in Table 9:

TABLE 9
MEAN ABSOLUTE ERROR
(MAE) AND ROOT MEAN
SQUARE ERROR (RMSE)

| | Mean | Root Mean |
|---|---|---|
| Model/ | Absolute | Square Error |
| Solution | Error (MAE) | (RMSE) |
| FNI | 0.6 | 0.7 |
| | bbl/day/psi | bbl/day/psi |
| Model A | 0.8 | 1.1 |
| | bbl/day/psi | bbl/day/psi |
| Model B | 1.0 | 1.3 |
| | bbl/day/psi | bbl/day/psi |
| | 0.9 | 1.2 |
| Model C | bbl/day/psi | bbl/day/psi |

As shown in Table 9, the fuzzy-neural model predicts the production index with greater than 36% less than the average error of the best available commercial solution.

To evaluate robustness of the model, the variance for the fuzzy-neural model (FNI), Model A, Model B, and Model C was calculated, as shown in Table 10:

TABLE 10
VARIANCE

| Model/ | |
|---|---|
| Solution | Variance |
| FNI | 0.06 |
| Model A | 0.08 |
| Model B | 0.1 |
| Model C | 0.09 |

As shown in Table 10, the fuzzy-neural model had a significantly lower variance than the commercial solutions, indicating that the model is consistent across different datasets and more stable and less sensitive to fluctuations in the data.

To evaluate the generalization capability of the fuzzy-neural model, a cross validation score was calculated for the for the fuzzy-neural model (FNI), Model A, Model B, and Model C was calculated, as shown in Table 11:

TABLE 11
CROSS-
VALIDATION SCORE

| | Cross- |
|---|---|
| Model/ | Validation |
| Solution | Score |
| FNI | 0.92 |
| Model A | 0.86 |
| Model B | 0.83 |
| Model C | 0.84 |

As shown in Table 11, the fuzzy-neural model has an average cross-validation score of 92% accuracy as compared to a score of 86% for the best commercial solution, indicating a superior generalization capability of fuzzy-neural model.

To evaluate the computational efficiency of the fuzzy-neural model, the training time and prediction time was calculated for the fuzzy-neural model (FNI), Model A, Model B, and Model C was calculated, as shown in Table 12:

TABLE 12
COMPUTATIONAL
EFFICIENCY SCORE

| | Training | Prediction |
|---|---|---|
| Model/ | Time | Time |
| Solution | (seconds) | (milliseconds) |
| FNI | 10 | 2 |
| Model A | 16 | 3 |
| Model B | 20 | 4 |
| Model C | 18 | 3.6 |

As shown in Table 12, the fuzzy-neural model is trained in 10 seconds on a standard dataset, while the best commercial solution is trained in 16 seconds, indicating that the fuzzy-neural model has a more efficient training capability. Additionally, as also shown in Table 12, the fuzzy-neural model makes predictions in 2 milliseconds per data point, as compared to 3 milliseconds per data point for the best commercial solution, showing a 1.6 times improvement in prediction speed.

Additionally, the model interpretability of the fuzzy-neural model was evaluated by comparing the number of rules generated to Model A, Model B, and Model C, as shown in Table 13:

TABLE 13
NUMBER OF
RULES GENERATED

| | Number |
|---|---|
| Model/ | of Rules |
| Solution | Generated |
| FNI | 6 |
| Model A | 10 |
| Model B | 12 |
| Model C | 11 |

As shown in Table 13, the fuzzy-neural model generates 6 rules, as compared to 10 rules for the best commercial solution, indicating that the fuzzy-neural model provides a more concise and understandable model.

To evaluate the adaptability of the fuzzy-neural model, the retraining frequency for the fuzzy-neural model (FNI) was compared with Model A, Model B, and Model C was calculated, as shown in Table 14:

TABLE 14
RETRAINING
FREQUENCY

| Model/ | Retraining |
|---|---|
| Solution | Frequency |
| FNI | Once every 6 |
| | months |
| Model A | Once every 4 |
| | months |
| Model B | Once every 3 |
| | months |
| Model C | Once every 6 |
| | months |

As shown in Table 14, the fuzzy-neural model only required retraining every 6 months, as compared to 6 months for the best commercial solution. This indicates that the fuzzy-neural model is more adaptable and less maintenance-intensive.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method for determining the production index of a selected well, comprising:
obtaining a first plurality of parameters and respective values associated with one or more producing wells;
processing the plurality of parameters and respective values to obtain a training dataset and testing dataset;
fuzzifying the training dataset, the fuzzifying comprising:
creating a plurality of fuzzy sets, each fuzzy set comprising a plurality of fuzzy inputs; and
creating a plurality of rules that produce a plurality of fuzzy values for a production index from the plurality of fuzzy inputs;
training a neural network using the plurality of a fuzzy values for the production index to create a fuzzy-neural model; and
using the trained fuzzy-neural model to determine a production index for the selected well from a second plurality of parameters and respective values associated with the selected well.

2. The method of claim 1, wherein processing the plurality of parameters and respective values comprising normalizing the plurality of respective values to a range.

3. The method of claim 1, wherein the first plurality of parameters comprise a plurality of reservoir properties.

4. The method of claim 1, wherein the first plurality of parameters comprise a plurality of well characteristics.

5. The method of claim 1, wherein the first plurality of parameters comprise a production rate.

6. The method of claim 1, wherein the neural network comprises a feed-forward neural network.

7. The method of claim 1, comprising evaluating the fuzzy-neural model before using the trained fuzzy-neural model to determine a production index for the selected well, wherein evaluating the fuzzy-neural model comprises:
calculating a metric between a production index produced by the fuzzy-neural model and a production index in the training data, wherein the metric comprises a mean absolute error, a mean squared error, or a root mean squared error.

8. The method of claim 7, comprising adjusting the fuzzy-neural model based on the evaluation of the fuzzy-neural model, wherein adjusting the fuzzy-neural model comprises modifying the neural network, tuning a hyperparameter of the neural network, or modifying the plurality of rules.

9. The method of claim 1, comprising:
determining, based on production index, an operating parameter for the producing well; and
operating the hydrocarbon well in accordance with the operating parameter.

10. A non-transitory computer readable storage medium comprising program instructions stored thereon for determining the production index of a selected well, the program instructions executable by a processor to perform operations comprising:
obtaining a first plurality of parameters and respective values associated with one or more producing wells;
processing the plurality of parameters and respective values to obtain a training dataset and testing dataset;
fuzzifying the training dataset, the fuzzifying comprising:
creating a plurality of fuzzy sets, each fuzzy set comprising a plurality of fuzzy inputs; and
creating a plurality of rules that produce a plurality of fuzzy values for a production index from the plurality of fuzzy inputs;
training a neural network using the plurality of a fuzzy values for the production index to create a fuzzy-neural model; and
using the trained fuzzy-neural model to determine a production index for the selected well from a second plurality of parameters and respective values associated with the selected well.

11. The non-transitory computer readable storage medium of claim 10, wherein processing the plurality of parameters and respective values comprising normalizing the plurality of respective values to a range.

12. The non-transitory computer readable storage medium of claim 10, wherein the first plurality of parameters comprise a plurality of reservoir properties.

13. The non-transitory computer readable storage medium of claim 10, wherein the first plurality of parameters comprise a plurality of well characteristics.

14. The non-transitory computer readable storage medium of claim 10, wherein the first plurality of parameters comprise a production rate.

15. The non-transitory computer readable storage medium of claim 10, wherein the neural network comprises a feed-forward neural network.

16. The non-transitory computer readable storage medium of claim 10, the operations comprising evaluating the fuzzy-neural model before using the trained fuzzy-neural model to determine a production index for the selected well, wherein evaluating the fuzzy-neural model comprises:
calculating a metric between a production index produced by the fuzzy-neural model and a production index in the training data, wherein the metric comprises a mean absolute error, a mean squared error, or a root mean squared error.

17. The non-transitory computer readable storage medium of claim 16, the operations comprising adjusting the fuzzy-neural model based on the evaluation of the fuzzy-neural model, wherein adjusting the fuzzy-neural model comprises modifying the neural network, tuning a hyperparameter of the neural network, or modifying the plurality of rules.

18. The non-transitory computer readable storage medium of claim 10, the operations comprising:
determining, based on production index, an operating parameter for the producing well; and
operating the hydrocarbon well in accordance with the operating parameter.

19. A system for determining the production index of a selected well, comprising:
a processor;
a non-transitory computer-readable memory accessible by the processor and having executable code stored thereon, the executable code comprising a set of instructions that causes a processor to perform operations comprising:
obtaining a first plurality of parameters and respective values associated with one or more producing wells;
processing the plurality of parameters and respective values to obtain a training dataset and testing dataset;
fuzzifying the training dataset, the fuzzifying comprising:
creating a plurality of fuzzy sets, each fuzzy set comprising a plurality of fuzzy inputs; and
creating a plurality of rules that produce a plurality of fuzzy values for a production index from the plurality of fuzzy inputs;
training a neural network using the plurality of a fuzzy values for the production index to create a fuzzy-neural model; and
using the trained fuzzy-neural model to determine a production index for the selected well from a second plurality of parameters and respective values associated with the selected well.

20. The system of claim 19, wherein processing the plurality of parameters and respective values comprising normalizing the plurality of respective values to a range.

21. The system of claim 19, wherein the first plurality of parameters comprise a plurality of reservoir properties.

22. The system of claim 19, wherein the first plurality of parameters comprise a plurality of well characteristics.

23. The system of claim 19, wherein the first plurality of parameters comprise a production rate.

24. The system of claim 19, the operations comprising:
determining, based on production index, an operating parameter for the producing well; and
operating the hydrocarbon well in accordance with the operating parameter.
